(19) United States
(12) Patent Application Publication
(10) Pub. No.: US 2022/0335312 A1
(43) Pub. Date: Oct. 20, 2022

(54) SYSTEM AND METHOD FOR DISTRIBUTED MODEL ADAPTATION

(71) Applicant: EMC IP Holding Company LLC, Hopkinton, MA (US)

(72) Inventors: Pablo Nascimento da Silva, Niterói (BR); Hugo de Oliveira Barbalho, Rio de Janeiro (BR)

(21) Appl. No.: 17/231,883

(22) Filed: Apr. 15, 2021

(51) Int. Cl. G06N 5/04; G06N 3/02; G06K 9/62

(52) U.S. Cl. CPC G06N 5/04; G06N 3/02; G06K 9/6259

(57) ABSTRACT

An information handling system includes storage and a processor. The processor identifies an occurrence of an inference model update event; in response to identifying the inference model update event: generates an inference model update package; provides the inference model update package to an entity that generated an inference model used by the information handling system; obtains, from the entity, a hybrid data adapted inference model that is based on the inference model, the inference model update package, and labeled data used to train the inference model; and obtains an inference, using the hybrid data adapted inference model, that indicates a feature is present in collected data.

### BACKGROUND

Computing devices may provide services. To provide the services, the computing devices may include hardware components and software components. The services provided by the computing devices may be limited by these hardware components.

### SUMMARY

In one aspect, an information handling system in accordance with one or more embodiments of the invention includes storage for storing collected data and inference models. The information handling system also includes a processor that identifies an occurrence of an inference model update event for an inference model of the inference models; in response to identifying the inference model update event: generates an inference model update package for the inference model, the inference model update package includes a result of a calculation performed on a portion of the collected data usable to partially adapt the inference model to detect a feature in the portion of the collected data; provides the inference model update package to an entity that generated the inference model; obtains, from the entity, a hybrid data adapted inference model that is based on: the inference model, the inference model update package, and labeled data used to train the inference mode and stored in the entity; and obtains an inference, using the hybrid data adapted inference model and a second portion of the collected data, that indicates a second feature is present in the second portion of the collected data.

In one aspect, a method for detecting features in collected data hosted by an information handling system using inference models in accordance with one or more embodiments of the invention includes identifying an occurrence of an inference model update event for an inference model of the inference models; in response to the inference model update event: generating, by the information handling system, an inference model update package for the inference model, the inference model update package including a result of a calculation performed on a portion of the collected data usable to partially adapt the inference model to detect a feature of the features in the portion of the collected data; providing the inference model update package to an entity that is operably connected to the information handling system by a network and that generated the inference model; obtaining, by the information handling system and from the entity, a hybrid data adapted inference model that is based on: the inference model, the inference model update package, and labeled data used to train the inference mode and stored in the entity; and obtaining, by the information handling system, an inference, using the hybrid data adapted inference model and a second portion of the collected data, that indicates a second feature of the features is present in the second portion of the collected data.

In one aspect, a non-transitory computer readable medium in accordance with one or more embodiments of the invention includes computer readable program code, which when executed by a computer processor enables the computer processor to perform a method for detecting features in collected data hosted by an information handling system using inference models. The method includes identifying an occurrence of an inference model update event for an inference model of the inference models; in response to the inference model update event: generating, by the information handling system, an inference model update package for the inference model, the inference model update package including a result of a calculation performed on a portion of the collected data usable to partially adapt the inference model to detect a feature of the features in the portion of the collected data; providing the inference model update package to an entity that is operably connected to the information handling system by a network and that generated the inference model; obtaining, by the information handling system and from the entity, a hybrid data adapted inference model that is based on: the inference model, the inference model update package, and labeled data used to train the inference mode and stored in the entity; and obtaining, by the information handling system, an inference, using the hybrid data adapted inference model and a second portion of the collected data, that indicates a second feature of the features is present in the second portion of the collected data.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1 shows a diagram of a system in accordance with one or more embodiments of the invention.

FIG. 2.1 shows a diagram of an information handling system in accordance with one or more embodiments of the invention.

FIG. 2.2 shows a diagram of a model repository in accordance with one or more embodiments of the invention.

FIG. 3.1 shows a diagram of an information handling system manager in accordance with one or more embodiments of the invention.

FIG. 3.2 shows a diagram of relationships that may be present in the system of FIG. 1 in accordance with one or more embodiments of the invention.

FIG. 4.1 shows a flowchart of a method of providing an inference model in accordance with one or more embodiments of the invention.

FIG. 4.2 shows a flowchart of a method of updating an inference model in accordance with one or more embodiments of the invention.

FIG. 5 shows a flowchart of a method of identifying features in unlabeled data in accordance with one or more embodiments of the invention.

FIGS. 6.1-6.4 show diagrams illustrating the operation of a system over time in accordance with one or more embodiments of the invention.

FIG. 7 shows a diagram of a computing device in accordance with one or more embodiments of the invention.

### DETAILED DESCRIPTION

Specific embodiments will now be described with reference to the accompanying figures. In the following description, numerous details are set forth as examples of the invention. It will be understood by those skilled in the art that one or more embodiments of the present invention may be practiced without these specific details and that numerous variations or modifications may be possible without departing from the scope of the invention. Certain details known to those of ordinary skill in the art are omitted to avoid obscuring the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

In general, embodiments of the invention relate to systems, devices, and methods for identifying features in unlabeled data. Unlabeled data may include one or more features that are not explicitly identified by metadata or the data structure itself. For example, an image showing a scene in which a person is disposed may include a feature of a person.

In contrast, labeled data may be data for which metadata is available that explicitly identifies one or more features included in the data. For example, an image that is tagged with a name of a person may be labeled data because it explicitly identifies the presence of the person within the image.

To identify features in unlabeled data, an inference model may be used. An inference model may be, for example, a neural network trained to identify the presence of one or more features in data. However, the accuracy of the inferences made by the inference model may be limited by the information on which the inference model is based. For example, an inference model may only be capable of providing accurate inferences if the character of unlabeled data is similar to that upon which the inference model is based.

Embodiments of the invention may provide methods and system for maintaining the accuracy of inference models as unlabeled data that deviates in character from that of the data upon which the inference model is based is encountered. To do so, a system in accordance with embodiments of the invention may retrain the inference model, in part, based on unlabeled data of a similar character to that upon which inferences will be made. By doing so, the accuracy of the inferences made by a system in accordance with embodiments of the invention may be maintained over time.

Additionally, to enable low computational resources devices such as autonomous vehicles or building management systems to utilize inference models, a system in accordance with embodiments of the invention may primarily utilize other devices to generate the inference models (e.g., due to the heavy computational load involved with generating the inference models).

To do so, the system may divide the process of retraining inference models between tasks that must be carried out using unlabeled data (e.g., that obtained by the low computational resources devices) and other tasks that must be carried out using labeled data (e.g., that maintained by other devices). By doing so, only the results of such computations (rather than the underlying data) may need to be transferred between the devices to retrain an inference model. Consequently, the communications resources necessary to retrain an inference model may be reduced while also maintaining the privacy of unlabeled data collected by the low computational resources devices.

Maintaining the privacy of the unlabeled data may be useful. For example, consider a scenario where an autonomous vehicle is attempting to navigate a city. In doing so, the autonomous vehicle may take images of the area thereby capturing photos that persons in the area may consider to be an invasion of their privacy. While it may not be illegal, the person may not desire to have photos of them be transferred to other devices (e.g., thereby exposing them to some risk that the pictures could be improperly disseminated). A system in accordance with embodiments of the invention may be able to comply with the desires of such persons because, as noted above, the photos of the persons may not need to be transferred beyond the autonomous vehicle for feature identification purposes.

Thus, embodiments of the invention may address a myriad number of problems including limited computing resources at various locations within distributed system and limitations on transmission of data within distributed systems.

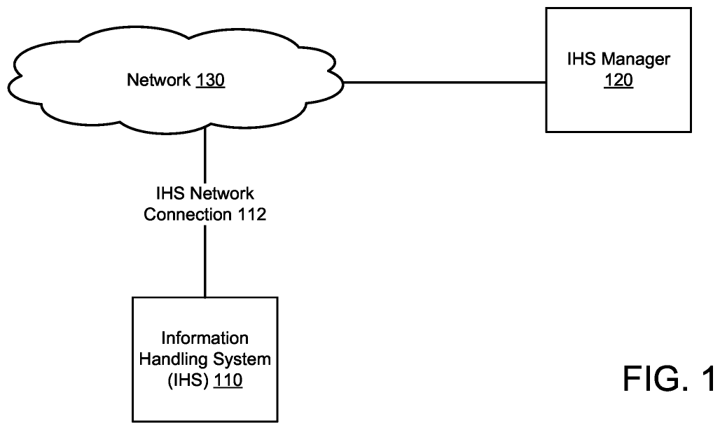

Turning to FIG. 1, FIG. 1 shows a system in accordance with one or more embodiments of the invention. The system may include an information handling system (110). The information handling system my collect information and use the collected information to provide its functionalities. The information collected by the information handling system (110) may be any type and quantity of information.

In one or more embodiments of the invention, the collected information relates to an environment in which the information handling system resides. For example, the information handling system (110) may be a part of a larger device such as, for example, an automobile, an autonomous vehicle, a drone, a building management system, and/or other types of devices.

The collected information may be collected from any number of sources. The sources may include, for example, sensors such as cameras, microphone, radars, and/or other types of devices. The sources may also include, for example, other devices (not shown) operably connected to the information handling system (110) via one or more networks (e.g., 130).

Metadata regarding data structures in which the collected information is stored may also be collected along with the collected information. The metadata may specify, for example, when the data was collected, the entity that collected the collected information, and/or other characteristics of the collected information and/or data structure in which the collected information is stored. However, the collected information may include additional information now expressly identified by the metadata.

For example, consider a scenario where a camera is used to obtain an image of a scene. When collected, the camera may append (or otherwise associated with) information such as, for example, a creation data, a name, a size, a location, and/or other types of metadata with the data structure in which the image is stored. However, the pixels of the image may also include additional information not explicitly noted by the metadata. For example, if a person is included in the image, a person viewing the image may recognize the person. Similarly, if an image includes a busy roadway, a person may be able to identify road sign, road conditions, and other information not explicitly noted in the metadata. These types of information included in collected data but not explicitly identified by the metadata may be referred to as features included in the collected data.

To provide its services, the information handling system (110) may utilize the features (and/or information regarding the features). For example, if the information handling system (110) is a part of an autonomous vehicle, the information handling system (110) may utilize roadway features identified in the collected information to provide navigation services. In another example, if the information handling system (110) is a part of a building, the information handling system (110) may utilize the motions of persons within the building identified in the collected information to manage the heating and/or cooling of various rooms within the building, turn on/or lighting, and/or automatically manage other pieces of infrastructure within the building.

To utilize the features included in the collected information, the information handling system (110) may analyze the collected information. To do so, the information handling system (110) may use an inference framework such as neural networks to identify the features included in the collected information. The frameworks may include various types of inference models used by the information handling system (110) to make inferences.

An inference models may include, for example, (i) data structures based on known relationships between data and features included in the data (e.g., training data in the context of a neural network) and (ii) instructions for using the data structures to obtain inferences using input data (e.g., collected information).

The inference frameworks utilized by the information handling system (110) may be capable of identifying features within the collected information by training or otherwise adapting the inference frameworks using a labeled data set. A labeled data set may be collected information in which the features are known. For example, a person may review some amount of collected information to identify the features included in the collected information. Once trained, the inference frameworks may be capable of identifying the features included in unlabeled collected information.

However, the inference frameworks may not be perfectly accurate in identifying features within collected information. Due to a limited quantity of labeled data usable for training purposes, the inference frameworks may only accurate identify features in collected data that is similar to the limited quantity of labeled data. For example, if the limited quantity of labeled data only includes images from sunny days, inference frameworks trained using this limited quantity of labeled data may only be capable of accurately identifying features within images that are taken on sunny days (and may be inaccurate for images taken on cloudy, rainy, snowy, etc. days).

Due to changing conditions in which the information handling system (110) may reside and the limited quantity of labeled data available to train its inference frameworks, the accuracy of inferences made by an inference framework after it is obtained may change over time, may become inaccurate, or may otherwise become undesirable and reduce the quality of the services provided by the information handling system (110).

In general, embodiments of the invention relate to systems, devices, and methods for identifying features included in collected information. Specifically, embodiments of the invention may provide a method for identifying features that is able to adapt to changes in collected information over time. To do so, the inference frameworks may be periodically retrained based on a combination of labeled data and unlabeled collected data from the information handling system (110). By doing so, the accuracy of features identified using the inference frameworks may be improved.

However, generating and updating inference frameworks may be a computationally expensive task. For example, large numbers of labeled and/or unlabeled data may be utilized and significant processing resources may be required to generate and/or update the frameworks.

In one or more embodiments of the invention, the system of FIG. 1 may include an information handling system manager (120). The information handling system manager (120) may assist the information handling system (110) in generating and/or updating inference frameworks. The aforementioned devices may be operably connected via a network (130).

To assist the information handling system (110) in generating and/or updating inference frameworks, the information handling system manager (120) may (i) store the labeled data used to train inference frameworks and (ii) perform a majority of the calculations required to generate and/or update an inference model. For example, when a new inference framework is generated, the information handling system manager (120) may perform all of the calculations using locally accessible (or otherwise not impacting the information handling system (110)) labeled data. The information handling system manager (120) may then provide the generated inference framework to the information handling system (110) for use in identifying features in unlabeled collected information.

Further, when a determination is made that an inference framework should be updated, the information handling system (110) and information handling system manager (120) may perform different portions of the calculations required to update the inference framework. For example, the information handling system (110) may perform only those calculations necessary to be performed using unlabeled collected information and may send the results of those calculations to the information handling system manager (120). In turn, the information handling system manager (120) may use those calculations to update a copy of the inference framework and provide the updated copy of the inference framework to the information handling system (110) for future use.

By doing so, the system of FIG. 1 may limit the computational load on the information handling system (110) thereby allowing the information handling system (110) to more efficiently marshal its limited computing resources. Additionally, by having the information handling system (110) perform a portion of the calculations necessary to update an inference framework, copies of the unlabeled collected information may not need to be provided to the information handling system manager (120). By doing so, the quantity of data transferred between the information handling system (110) and the information handling system manager (120) may be reduced. This may be particularly useful in scenarios where an information handling system connection (112) is unreliable, low performance, or for other reasons limits the ability of the information handling system (110) to communicate with other entities.

Additionally, by not needing to send copies of the unlabeled collected information to other entities for inference update purposes, the unlabeled collected information may be less exposed. For example, in some scenarios, the unlabeled collected information may include confidential, private, or other types of information that may not be able to be exposed to other entities (e.g., via contractual relationship, legal right, etc.). Accordingly, the system of FIG. 1 may be able to more accurately identify features in collected information while maintaining the privacy of the collected information.

The system of FIG. 1 may include any number of information handling systems (110) that provide services to any number of clients (not shown). The clients may be internal to the information handling systems or external (e.g., other devices). The system may also include any number of information handling system managers (120) that provide their functionalities to any number of the information handling systems. Any of the components of FIG. 1 may be operably connected to any other component and/or other components not illustrated in FIG. 1 via one or more networks (e.g., 120). The networks (e.g., 120) may be implemented using any combination of wired and/or wireless network topologies. The networks may employ any number and types of communication schemes to enable the clients (100) and information handling systems to communicate with each other.

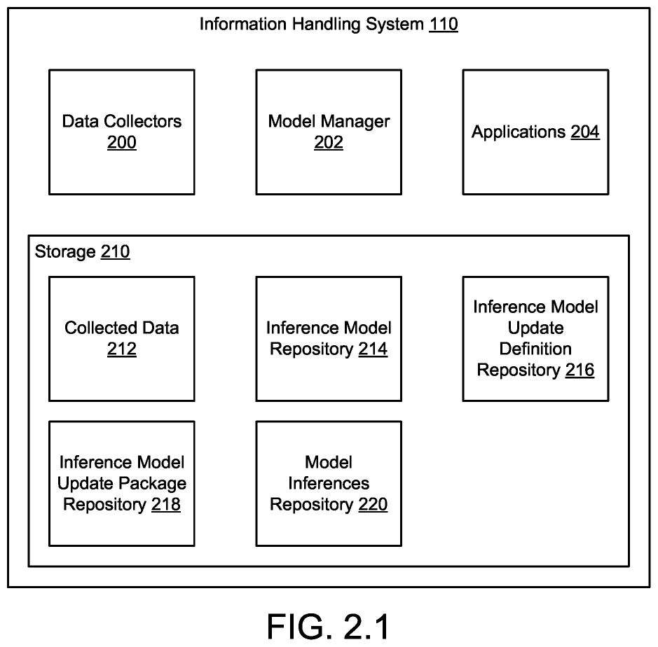

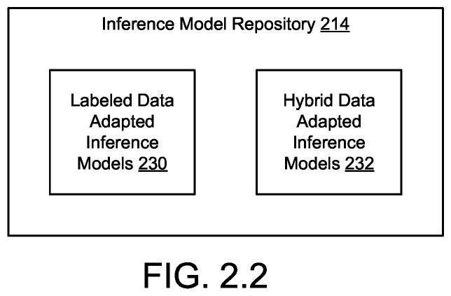

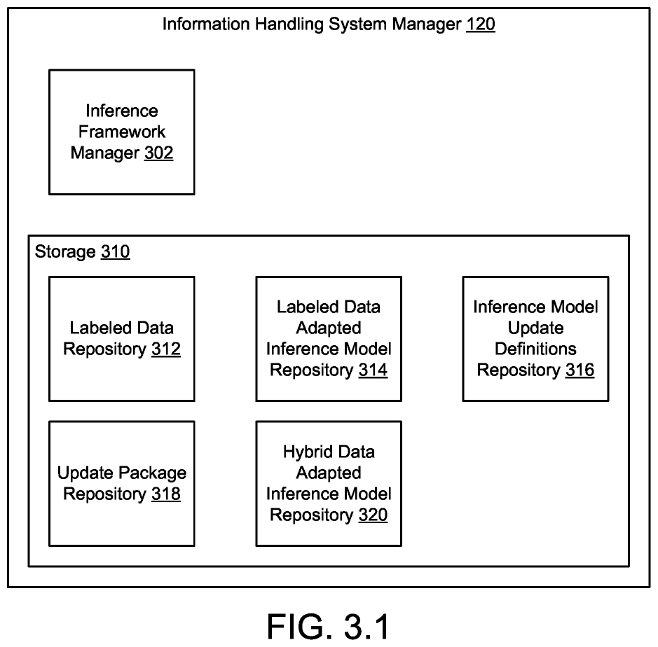

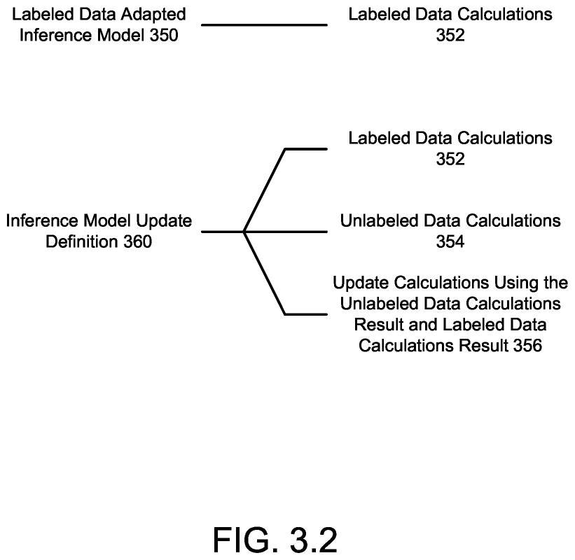

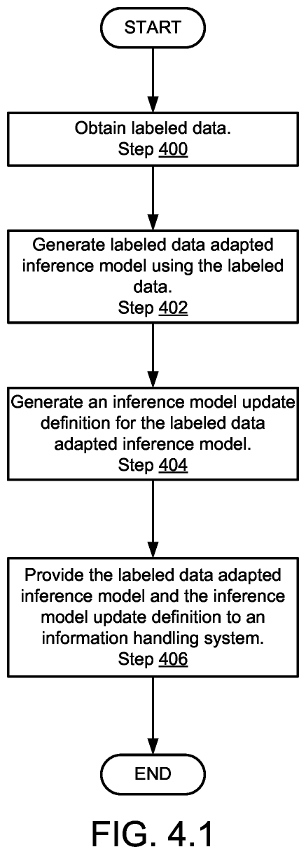

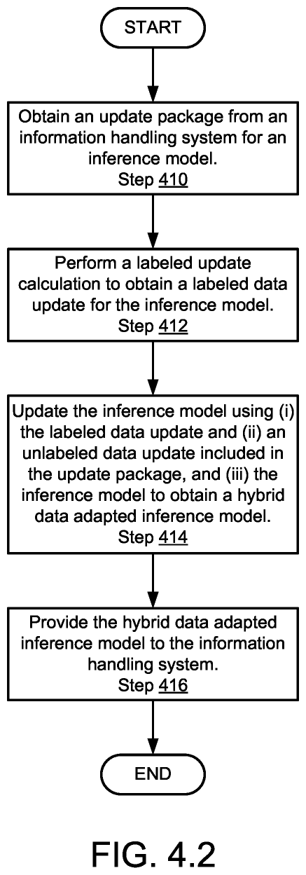

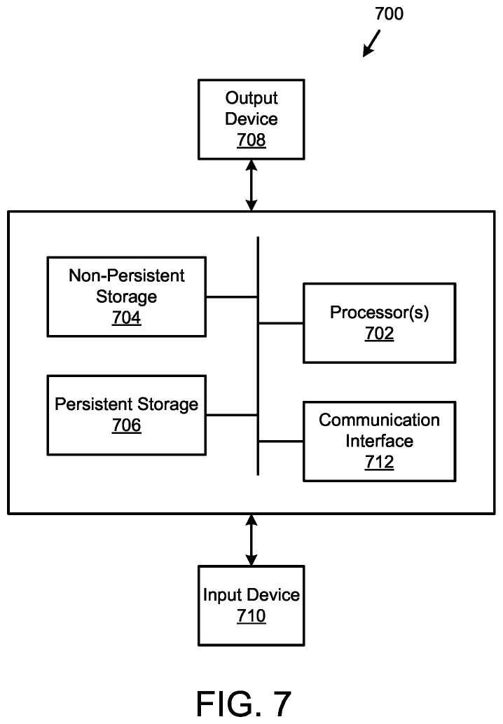

The information handling system (110) and/or information handling system manager (120) may be implemented using computing devices. The computing devices may include, for example, a server, laptop computer, a desktop computer, a node of a distributed system, etc. The computing device may include one or more processors, memory (e.g., random access memory), and/or persistent storage (e.g., disk drives, solid state drives, etc.). The persistent storage may store computer instructions, e.g., computer code, that (when executed by the processor(s) of the computing device) cause the computing device to perform the functions of the information handling system (110) and/or information handling system manager (120) described in this application and/or all, or a portion, of the methods illustrated in FIGS. 4.1-5. The information handling system (110) and/or information handling system manager (120) may be implemented using other types of computing devices without departing from the invention. For additional details regarding computing devices, refer to FIG. 7. For additional details regarding the information handling system (110), refer to FIGS. 2.1-2.3. For additional details regarding the information handling system manager (120), refer to FIGS. 3.1-3.2.

While the system of FIG. 1 has been illustrated and described as including a limited number of specific components, a system in accordance with embodiments of the invention may include additional, fewer, and/or different components without departing from the invention.

Turning to FIG. 2.1, FIG. 2.1 shows a diagram of an information handling system (110) in accordance with one or more embodiments of the invention. As discussed above, the information handling system (110) may provide services to clients.

To provide the services, the information handling system (110) may include data collectors (200), a model manager (202), applications (204), and storage (210). Each of these components is discussed below.

Data collectors (200) may collect information and/or store the collected information in data structures (e.g., 212) in storage (210). The data collectors (200) may obtain the collected information using any method without departing from the invention. The data collectors (200) may be implemented using, for example, sensors or other types of devices for generating the collecting information (e.g., regarding an environment in which a device of which the information handling system (110) is a component or operably connected), program that obtain the collected information from other sources, etc. The information handling system (110) may include any number of type of data collectors that collect any type and quantity of information.

The model manager (202) may provide model management services. The model management services may be used to identify features within the collected data (212). By doing so, the applications (204) and/or other entities may be better able to provide their respective services using the features. The features may be stored in a model inferences repository (220).

For example, consider a scenario where a data collector is implemented as a camera that obtains images of a roadway on which an autonomous vehicle is traversing. The model manager (202) may utilize an inference model from an inference model repository (214) to identify that a stop sign (e.g., a feature) is present in the image. Once identified, the stop sign feature may be added to the model inferences repository (220). An application tasked with navigating the roadway may use the stop sign feature in the model inferences repository (220) to plan a path and/or stop based on the stop sign feature. Consequently, by having access to the stop sign feature, the application may be better able to provide its navigation service.

To provide model management services, the model manager (202) may (i) utilize inference models to identify features in the collected data (212), (ii) assess the accuracy of the inferences made by the inference models, (iii) based on the assessed accuracies, initiate updating of the inference models when the assessed accuracies fall below a threshold level, (iv) perform calculations on the unlabeled collected data in accordance with inference model update definitions to obtain an update package usable to partially update an inference model, (v) provide the update package to an information handling system manager, (vi) obtain an updated inference model based, in part, on the update package from the information handling system manager, and (vii) use the updated inference model to identify features in collected information. By doing so, the services provided by the information handling system (110) may be improved by improving the rate of accurate identification of features within collected data while limiting the added computational load on the information handling system (110) when doing so.

When providing its functionality, the model manager (202) may perform all, or a portion, of the methods illustrated in FIGS. 4.1-5.

The applications (204) may provide computer implemented services. The applications (204) may be similar to or different from applications hosted by clients that provide similar or different computer implemented services. When providing their services, the applications (204) may use features in the model inference repository (220). Consequently, the accuracy of feature identification may impact the quality of services provided by the applications (204). The applications (204) may provide any type and quantity of computer implemented services without departing from the invention.

In one or more embodiments of the invention, the data collectors (200) model manager (202), and/or the applications (204) are implemented using a hardware device including circuitry. The hardware device may be, for example, a digital signal processor, a field programmable gate array, or an application specific integrated circuit. The circuitry may be adapted to cause the hardware device to perform the functionality of the data collectors (200) model manager (202), and/or the applications (204). The data collectors (200) model manager (202), and/or the applications (204) may be implemented using other types of hardware devices without departing from the invention.

In one or more embodiments of the invention, the data collectors (200) model manager (202), and/or the applications (204) are implemented using a processor adapted to execute computing code stored on a persistent storage that when executed by the processor performs the functionality of the data collectors (200) model manager (202), and/or the applications (204). The processor may be a hardware processor including circuitry such as, for example, a central processing unit or a microcontroller. The processor may be other types of hardware devices for processing digital information without departing from the invention.

As used herein, an entity that is programmed to perform a function (e.g., step, action, etc.) refers to one or more hardware devices (e.g., processors, digital signal processors, field programmable gate arrays, application specific integrated circuits, etc.) that provide the function. The hardware devices may be programmed to do so by, for example, being able to execute computer instructions (e.g., computer code) that cause the hardware devices to provide the function. In another example, the hardware device may be programmed to do so by having circuitry that has been adapted (e.g., modified) to perform the function. An entity that is programmed to perform a function does not include computer instructions in isolation from any hardware devices. Computer instructions may be used to program a hardware device that, when programmed, provides the function.

In one or more embodiments disclosed herein, the storage (210) is implemented using physical devices that provide data storage services (e.g., storing data and providing copies of previously stored data). The devices that provide data storage services may include hardware devices and/or logical devices. For example, storage (210) may include any quantity and/or combination of memory devices (i.e., volatile storage), long term storage devices (i.e., persistent storage), other types of hardware devices that may provide short term and/or long term data storage services, and/or logical storage devices (e.g., virtual persistent storage/virtual volatile storage).

For example, storage (210) may include a memory device (e.g., a dual in line memory device) in which data is stored and from which copies of previously stored data are provided. In another example, storage (210) may include a persistent storage device (e.g., a solid-state disk drive) in which data is stored and from which copies of previously stored data is provided. In a still further example, storage (210) may include (i) a memory device (e.g., a dual in line memory device) in which data is stored and from which copies of previously stored data are provided and (ii) a persistent storage device that stores a copy of the data stored in the memory device (e.g., to provide a copy of the data in the event that power loss or other issues with the memory device that may impact its ability to maintain the copy of the data cause the memory device to lose the data).

The storage (210) may also be implemented using logical storage. A logical storage (e.g., virtual disk) may be implemented using one or more physical storage devices whose storage resources (all, or a portion) are allocated for use using a software layer. Thus, a logical storage may include both physical storage devices and an entity executing on a processor or other hardware device that allocates the storage resources of the physical storage devices.

The storage (210) may store data structures including, for example, collected data (212), an inference model repository (214), an inference model update definition repository (216), an inference model update package repository (218), and/or a model inference repository (220). Each of these data structures is discussed below.

The collected data (212) may be implemented using one or more data structures that includes information in which features may be present. For example, the collected data (212) may include images, audio files, video files, unstructured data, databases, etc.

The collected data (212) may be maintained by, for example, the data collectors (200). For example, the data collectors (200) may add, remove, and/or modify information included in the collected data (212).

The data structures of the collected data (212) may be implemented using, for example, lists, tables, unstructured data, databases, etc. While illustrated in FIG. 2.1 as being stored locally, the collected data (212) may be stored remotely and may be distributed across any number of devices without departing from the invention.

The inference model repository (214) may be implemented using one or more data structures that includes inference models and/or information regarding inference models. The inference model repository (214) may include any number and type of inference models. For example, the inference model repository may include labeled data adapted inference models (e.g., inference models based only on labeled data), hybrid data adapted inference models (e.g., inference models based on labeled data and unlabeled data), and/or other types of modes. The inference model repository (214) may also include, for example, which inference models may be usable to identify features on various portions of the collected data (212).

The inference model repository (214) may be maintained by, for example, the model manager (202). For example, the model manager (202) may add, remove, and/or modify information included in the inference model repository (214).

The data structures of the inference model repository (214) may be implemented using, for example, lists, tables, unstructured data, databases, etc. While illustrated in FIG. 2.1 as being stored locally, the inference model repository (214) may be stored remotely and may be distributed across any number of devices without departing from the invention. For additional details regarding the inference model repository (214), refer to FIG. 2.2.

The inference model update definition repository (216) may be implemented using one or more data structures that include information regarding actions needed to be performed by the information handling system (110) to update an inference model. For example, the inference model update definition repository (216) may specify, for an example inference model, the calculations that need to be performed over a portion of the collected data (e.g., unlabeled data) to obtain all, or a portion, of an update package.

The inference model update definition repository (216) may be maintained by, for example, the model manager (202). For example, the model manager (202) may add, remove, and/or modify information included in the inference model repository (214).

The data structures of the inference model update definition repository (216) may be implemented using, for example, lists, tables, unstructured data, databases, etc. While illustrated in FIG. 2.1 as being stored locally, the inference model update definition repository (216) may be stored remotely and may be distributed across any number of devices without departing from the invention.

The inference model update package repository (218) may be implemented using one or more data structures that include update packages obtained using inference model update definitions and/or information regarding the update packages.

The inference model update package repository (218) may be maintained by, for example, the model manager (202). For example, the model manager (202) may add, remove, and/or modify information included in the inference model repository (214).

The data structures of the inference model update package repository (218) may be implemented using, for example, lists, tables, unstructured data, databases, etc. While illustrated in FIG. 2.1 as being stored locally, the inference model update package repository (218) may be stored remotely and may be distributed across any number of devices without departing from the invention.

The model inference repository (220) may be implemented using one or more data structures that include any number of features identified using inference models. The repository may include any number and type of features. The model inference repository (220) may also include information regarding the features including, for example, accuracy scores, identifiers of the inference models used to extract the features, etc.

The model inference repository (220) may be maintained by, for example, the model manager (202). For example, the model manager (202) may add, remove, and/or modify information included in the inference model repository (214).

The data structures of the model inference repository (220) may be implemented using, for example, lists, tables, unstructured data, databases, etc. While illustrated in FIG. 2.1 as being stored locally, the model inference repository (220) may be stored remotely and may be distributed across any number of devices without departing from the invention.

While the storage (210) has been illustrated and described as including a limited quantity and type of data, a storage in accordance with embodiments of the invention may store additional, less, and/or different data without departing from the invention.

While the information handling system (110) has been illustrated and described as including a limited number of specific components, an information handling system in accordance with embodiments of the invention may include additional, fewer, and/or different components without departing from the invention.

Turning to FIG. 2.1, FIG. 2.1 shows a diagram of an inference model repository (214) in accordance with one or more embodiments of the invention. The inference model repository (214) may store any number and type of inference models and/or information regarding the models (e.g., how to use the models, for which data the inference models should be used, information regarding how to determine whether the inference models are accurately identifying features included in data, etc.).

The inference model repository (214) may include labeled data adapted inference models (230). Labeled data adapted inference models (230) may be inference models trained using only labeled data. When an inference model is initially created, it may be created using only labeled data. For example, if an inference model is a neural network based inference model, the neural network may be trained using the labeled data.

In one or more embodiments of the invention, at least one of the labeled data adapted inference models (230) is a neural network based inference model. To generate such an inference model, by using a training algorithms that may be used that may be support by optimization (e.g., optimizing an objective function using the labels as the goal and the data as the domain). The neural network may be, for example, a deep neural network that utilizes a backpropagation algorithm and an optimization algorithm (e.g., Stochastic Gradient Descent (SGD) to train the deep neural network.

Prior to training, one network topology of neurons and interconnecting weights may be chosen. Any such topologies and interconnection weights may be used without departing from the invention. After the topology is established, the weight values may be set to random or predefined values. After the topology and weights are set, then the training algorithm may be used to separate batches of data and flow the data through the network. After flowing the data through the network, a backpropagation may be performed, which may set the direction of movement of each of the weights through one or more gradients (e.g., optimizing the objective function). Consequently, the weights are adjusted by a small amount in accordance with the optimization. The aforementioned process may be repeated for different portions of the labeled data until all, or a predetermined portion, of the labeled data is utilized for training purposes (this process referred to as a training cycle). Training cycles may be repeated until a predetermined number of training cycles have been completed or until one or more criteria are met (e.g., no significant changes in inference accuracy, weight change, topology adjustment, etc. from previous training cycles).

In one or more embodiments of the invention, at least one of the labeled data adapted inference models (230) is based on a domain adversarial neural network. A domain adversarial neural network may be a neural network that may be (i) initially trained using labeled data and (ii) updated using the labeled data, the unlabeled data, and the previously trained neural network.

The domain adversarial neural network may include (i) a pattern identifier (that is able to learn how to identify patterns that are discriminative and invariant between a source domain such as the labeled data and a target domain such as unlabeled data), (ii) a label predictor usable to identify a label (e.g., a feature within unlabeled data) corresponding to identified patterns, and/or (iii) a domain classifier usable to identify whether ingested data (e.g., unlabeled data being processed by the neural network) is from the source domain or the target domain. The label predictor may be trained exclusively using the labeled data while the domain classifier may be trained using labeled data and/or unlabeled data. Thus, when low accuracy identifications are being made by a trained inference model, the inference model may be retrained using additional unlabeled data.

By doing so, the inference model may be updated to better identify patterns and corresponding features included in unlabeled data by utilizing unlabeled data more closely resembling that being collected.

To train and/or retrain a domain adversarial neural network, an optimization function that optimizes the performance of the pattern identifier, label predictor, and domain classifier may be utilized. The optimization process may include (i) performing forward propagation, backpropagation, and gradient initialization with respect to the source domain (e.g., a first set of calculations using only the labeled data and providing a labeled data output), (ii) performing forward propagation, backpropagation, and gradient increment with respect to the target domain (e.g., a second set of calculations using only the unlabeled data and providing an unlabeled data output), and (iii) establishing and/or updating the weights and topology based on the objective function (which uses the labeled data output and unlabeled data output).

As will be discussed with greater detail with respect to FIGS. 3.1 and 3.2, the information handling system manager may manage the processes of obtaining and/or updating inference models. When doing so, the information handling system manager may have the information handling system perform some of the calculations (e.g., those with respect to the target domain to obtain the unlabeled data output) and may perform the other calculations required to obtain and/or update an inference model. Once obtained, the new/updated inference model may be provided (and/or along with information regarding the inference model) to the information handling system which may store the inference model in the inference model repository (214).

Inference models that are based (e.g., have been trained and/or updated using) on both labeled and unlabeled may be referred to as hybrid data adapted inference models. The inference model repository (214) may include any number of hybrid data adapted inference models (232).

While the inference model repository (214) has been illustrated as including a limited number and type of data structures, the inference model repository (214) may include additional, different, and/or fewer data structures than those illustrated in FIG. 2.2 without departing from the invention.

Turning to FIG. 3.1, FIG. 3.1 shows a diagram of an information handling system manager (120) in accordance with one or more embodiments of the invention. As discussed above, the information handling system manager (120) may orchestrate the generation and distribution of inference models to any number of information handling systems.

To do so, the information handling system (110) may include an inference framework manager (302) and storage (310). Each of these components is discussed below.

The inference framework manager (302) may provide inference framework services. The inference framework services may be used to ensure that information handling systems are able to accurately identify features included in unlabeled data. By doing so, the information handling systems may be better able to provide their respective services using the features.

To provide inference framework services, the inference framework manager (302) may (i) obtain and distribute labeled data adapted inference models and corresponding inference model update definitions and (ii) obtain and distribute hybrid data adapted inference models and corresponding inference model update definitions.

To obtain the labeled data adapted inference models, the inference framework manager (302) may train neural networks using labeled data stored in the labeled data repository (312). The neural networks may be trained as discussed with respect to FIG. 2.2. The labeled data adapted inference models may be stored in a labeled data adapted inference model repository (314).

To obtain the hybrid data adapted inference models, the inference framework manager (302) may train neural networks using the labeled data stored in the labeled data repository (312) and update packages stored in the update package repository (318). An update package may include the result of calculations performed by an information handling system based on an inference model update definition. An inference model update definition may specify the calculations to be performed by an information handling system to update an inference model. For example, as described with respect to FIG. 3.2, a neural network may be updated to better process unlabeled data by performing a first set of calculations with respect to labeled data, a second set of calculations with respect to unlabeled data, and a third set of calculations with respect to the result of the other calculations. Consequently, the calculations necessary to be performed to update a neural network may be distributed to the respective devices that host the data on which different portions of the calculations are performed. By doing so, the various portions of the labeled and/or unlabeled data may not need to be transferred between devices to update a neural network. Rather, merely the results of the calculations which may be vastly smaller (e.g., less than 0.1% the size of the data on which the calculations are performed) in size than the data on which the calculations are performed may need to be transferred to a single device to update the neural network (e.g., thereby adapting it to both labeled and/or unlabeled data for feature identification purposes).

When providing its functionality, the inference framework manager (302) may perform all, or a portion, of the methods illustrated in FIGS. 4.1-5.

In one or more embodiments of the invention, the inference framework manager (302) is implemented using a hardware device including circuitry. The hardware device may be, for example, a digital signal processor, a field programmable gate array, or an application specific integrated circuit. The circuitry may be adapted to cause the hardware device to perform the functionality of the inference framework manager (302). The inference framework manager (302) may be implemented using other types of hardware devices without departing from the invention.

In one or more embodiments of the invention, the inference framework manager (302) is implemented using a processor adapted to execute computing code stored on a persistent storage that when executed by the processor performs the functionality of the inference framework manager (302). The processor may be a hardware processor including circuitry such as, for example, a central processing unit or a microcontroller. The processor may be other types of hardware devices for processing digital information without departing from the invention.

As used herein, an entity that is programmed to perform a function (e.g., step, action, etc.) refers to one or more hardware devices (e.g., processors, digital signal processors, field programmable gate arrays, application specific integrated circuits, etc.) that provide the function. The hardware devices may be programmed to do so by, for example, being able to execute computer instructions (e.g., computer code) that cause the hardware devices to provide the function. In another example, the hardware device may be programmed to do so by having circuitry that has been adapted (e.g., modified) to perform the function. An entity that is programmed to perform a function does not include computer instructions in isolation from any hardware devices. Computer instructions may be used to program a hardware device that, when programmed, provides the function.

In one or more embodiments disclosed herein, the storage (310) is implemented using physical devices that provide data storage services (e.g., storing data and providing copies of previously stored data). The devices that provide data storage services may include hardware devices and/or logical devices. For example, storage (310) may include any quantity and/or combination of memory devices (i.e., volatile storage), long term storage devices (i.e., persistent storage), other types of hardware devices that may provide short term and/or long term data storage services, and/or logical storage devices (e.g., virtual persistent storage/virtual volatile storage).

For example, storage (310) may include a memory device (e.g., a dual in line memory device) in which data is stored and from which copies of previously stored data are provided. In another example, storage (310) may include a persistent storage device (e.g., a solid-state disk drive) in which data is stored and from which copies of previously stored data is provided. In a still further example, storage (310) may include (i) a memory device (e.g., a dual in line memory device) in which data is stored and from which copies of previously stored data are provided and (ii) a persistent storage device that stores a copy of the data stored in the memory device (e.g., to provide a copy of the data in the event that power loss or other issues with the memory device that may impact its ability to maintain the copy of the data cause the memory device to lose the data).

The storage (310) may also be implemented using logical storage. A logical storage (e.g., virtual disk) may be implemented using one or more physical storage devices whose storage resources (all, or a portion) are allocated for use using a software layer. Thus, a logical storage may include both physical storage devices and an entity executing on a processor or other hardware device that allocates the storage resources of the physical storage devices.

The storage (310) may store data structures including, for example, a labeled data repository (312), a labeled data adapted inference model repository (314), an inference model update definitions repository (316), an update package repository (318), and/or a hybrid data adapted inference model repository (320). Each of these data structures is discussed below.

The labeled data repository (312) may be implemented using one or more data structures that include any quantity and type of labeled data.

The labeled data adapted inference model repository (314) may be implemented using one or more data structures that include any number and type of labeled data adapted inference models and/or information regarding the inference models (e.g., applicability, deployment location, how to utilize the models, etc.).

The inference model update definitions repository (316) may be implemented using one or more data structures that include any number of inference model update definitions. An inference model update definition may include any type and quantity of information regarding the calculations to be performed to update an inference model. Information from an inference model update definition may be provided to an information handling system so that it is able to perform a portion of the calculations necessary to update an inference model (e.g., the calculations with respect to unlabeled data). Once calculated, the information handling system may provide an update package that includes the result of the calculations and/or other information to the information handling system manager (120) that enable the information handling system manager to update an inference model thereby adapting it to identify features included in unlabeled data and labeled data upon which the update is based.

The inference model update package repository (318) may be implemented using one or more data structures that include any number and type of update packages obtained from information handling systems. The update packages may include (i) the results of calculations performed with respect to unlabeled data necessary to update an inference model, (ii) a copy of or identifier of an inference model partially updatable using the results of the calculations, and/or (iii) other information usable to update the inference model.

The hybrid data adapted inference model repository (320) may be implemented using one or more data structures that include any number and type of hybrid data adapted inference models and/or information regarding the inference models (e.g., applicability, deployment location, how to utilize the models, etc.). Such models may be based on both labeled data and unlabeled data. The models may be obtained using labeled data hosted by the information handling system (and/or other entities) and update packages obtained from information handling systems.

The labeled data repository (312), labeled data adapted inference model repository (314), inference model update definitions repository (316), update package repository (318), and/or hybrid data adapted inference model repository (320) may be maintained by, for example, the inference framework manager (302). For example, the inference framework manager (302) may add, remove, and/or modify information included in the labeled data repository (312), labeled data adapted inference model repository (314), inference model update definitions repository (316), update package repository (318), and/or hybrid data adapted inference model repository (320).

The data structures of the labeled data repository (312), labeled data adapted inference model repository (314), inference model update definitions repository (316), update package repository (318), and/or hybrid data adapted inference model repository (320) may be implemented using, for example, lists, tables, unstructured data, databases, etc. While illustrated in FIG. 3.1 as being stored locally, all or a portion of the labeled data repository (312), labeled data adapted inference model repository (314), inference model update definitions repository (316), update package repository (318), and/or hybrid data adapted inference model repository (320) may be stored remotely and/or may be distributed across any number of devices without departing from the invention.

While the storage (310) has been illustrated and described as including a limited quantity and type of data, a storage in accordance with embodiments of the invention may store additional, less, and/or different data without departing from the invention.

While the information handling system manager (120) has been illustrated and described as including a limited number of specific components, an information handling system in accordance with embodiments of the invention may include additional, fewer, and/or different components without departing from the invention.

To further clarify aspects of embodiments of the invention, relationships that may exist within the system of FIG. 1 are illustrated in FIG. 3.2. FIG. 3.2 shows a diagram of relationships in accordance with one or more embodiments of the invention. The relationships may include (i) a first association between an inference model (e.g., 350) and a calculation (e.g., 352) and (ii) a second association between an update definition (e.g., 360) and calculations (e.g., 352, 354, 356) used to update an inference model.

Turning to the first association, to obtain a labeled data adapted inference model (350), a set of calculations may need to be performed. As illustrated in FIG. 3.2, these calculations may only include labeled data calculations (352). Consequently, a labeled data adapted inference model (350) may be obtained by only performing calculations using labeled data.

Turning to the second association, when an inference model is updated, a set of calculations may need to be performed. In the system of FIG. 1, these calculations may be performed by different devices thereby distributing the workload across the system and reducing the amount of data transferred between devices (when compared to scenarios in which a single device performs all of the calculations using data from multiple devices).

The inference model update definition (360) may specify the calculations necessary to be performed by each device within the system of FIG. 1. These calculations may include labeled data calculations (352) (e.g., a set of calculations performed using only labeled data to obtain a first result), unlabeled data calculations (354) (e.g., a second set of calculations performed using only unlabeled data to obtain a second result), and update calculations using the unlabeled data calculations result and the labeled data calculations result (356). Any of the calculations (e.g., 352, 354, 356) may be specified as, for example, lists of actions to be performed to obtain the calculation results and/or distribution of the calculation results (such as generating an update package and providing it to an information handling system manager).

Copies of the inference model update definition (360) and/or information based on the inference model update definition (360) may be distributed to the devices of FIG. 1 to orchestrate distributed performance of the calculations and distribution of the results to update an inference model.

As discussed above, the system of FIG. 1 may identify features in unlabeled data to provide computer implemented services to other entities. FIGS. 4.1-5 illustrate methods that may be performed by components of the system of FIG. 1 to provide computer implemented services.

FIG. 4.1 shows a flowchart of a method in accordance with one or more embodiments of the invention. The method depicted in FIG. 4.1 may be performed to provide labeled data adapted inference models to information handling systems in accordance with one or more embodiments of the invention. The method shown in FIG. 4.1 may be performed by, for example, an information handling system manager (e.g., 120, FIG. 1). Other components of the system in FIG. 1 may perform all, or a portion, of the method of FIG. 4.1 without departing from the invention.

While FIG. 4.1 is illustrated as a series of steps, any of the steps may be omitted, performed in a different order, additional steps may be included, and/or any or all of the steps may be performed in a parallel and/or partially overlapping manner without departing from the invention.

In step 400, labeled data is obtained. The labeled data may be obtained from any source and include any type and quantity of labeled data. The labeled data may include similar data to that which an information handling system may need to perform feature identification.

The labeled data may be obtained from a repository, another device, or another source without departing from the invention.

In step 402, a labeled data adapted inference model is generated using the labeled data. The labeled data adapted inference model may be generated by training or otherwise modifying an inference model to identify features within the labeled data. The inference model may be trained or otherwise modified using all or a portion of the inference data.

In one or more embodiments of the invention, the inference model is a neural network and the labeled data is used to train the inference mode. The labeled data may include, for example, data obtained by an information handling system that will use the labeled data adapted inference model or may obtain similar data to that of the labeled data (e.g., similar in character such as, for example, similar types of images).

In step 404, a model update definition for the labeled data adapted inference model is generated. As discussed above, the model update definition may be a data structure that includes information regarding the actions needed to be performed to update an inference model. The model update definition may specify (i) actions to be performed with respect to the labeled data and (ii) actions to be performed with respect to unlabeled data. The model update definition may specify that an information handling system using the labeled data adapted inference model may perform a portion of the actions, the unlabeled data need not be provided to the information handling system manager, that only a result of the actions may need to be provided to the information handling system manager in the form of an update package, and one or more thresholds or other factors for identifying whether the labeled data adapted inference model is accurately identifying features in unlabeled data.

In step 406, the labeled data adapted inference model and inference model update definition are provided to an information handling system. The model and definition may be provided to the information handling system via network communications or other means.

The method may end following step 406.

Using the method illustrated in FIG. 4.1, an information handling system may be able to identify features in unlabeled data using the labeled data adapted inference model, identify whether the labeled data adapted inference model is accurately identifying features, and perform actions appropriate to update the inference model to more accurately identify features.

FIG. 4.2 shows a flowchart of a method in accordance with one or more embodiments of the invention. The method depicted in FIG. 4.2 may be performed to provide labeled data adapted inference models to information handling systems in accordance with one or more embodiments of the invention. The method shown in FIG. 4.2 may be performed by, for example, an information handling system manager (e.g., 120, FIG. 1). Other components of the system in FIG. 1 may perform all, or a portion, of the method of FIG. 4.2 without departing from the invention.

While FIG. 4.2 is illustrated as a series of steps, any of the steps may be omitted, performed in a different order, additional steps may be included, and/or any or all of the steps may be performed in a parallel and/or partially overlapping manner without departing from the invention.

In step 410, an update package from an information handling system for an inference model is obtained. Prior to step 410, the information handling system may have encountered an inference model update event which may trigger generation of the update package. The information handling system may have generated the update package.

The update package may include (i) the result (e.g., an unlabeled data update) of an update calculation for the inference model with respect to a portion of unlabeled data (e.g., a target domain) and/or (ii) an identifier (e.g., usable by the information handling system manager to obtain a copy of the inference model) for the inference model and/or a copy of the inference model. The update calculation may be based on an inference model update definition associated with the inference model.

The update package may be obtained by, for example, receiving it as part of one or more messages, pulling down a copy of it by virtue of a publish-subscribe system, and/or via other mechanisms.

The inference model may be any type of inference model (e.g., labeled data adapted or hybrid data adapted or other type) without departing from the invention.

In step 412, a labeled data update calculation is performed to obtain a labeled data update for the inference model. The labeled data update may be based on (e.g., used as input) only labeled data. In contrast, the unlabeled data update may only be based on (e.g., used as input) unlabeled data hosted by the information handling system.

In step 414, the inference model is updated using (i) the labeled data update, (ii) an unlabeled data update included in the update package, and (iii) the inference model to obtain a hybrid data adapted inference model. The inference model may be updated by retraining the inference model using the processes described with respect to FIGS. 2.1-3.2. The hybrid data adapted inference model may be better able to accurately identify features in data similar to that of the unlabeled data used to obtain the unlabeled data update.

In step 416, the hybrid data adapted inference model is provided to the information handling system. The hybrid data adapted inference model may be provided to the information handling system via message passing, publish-subscribe systems, or any other method for disseminating information without departing from the invention.

The method may end following step 416.

Using the method illustrated in FIG. 4.2, inference models may be updated in a manner that does not require that unlabeled data be transferred between devices. Consequently, the privacy of the unlabeled data may not be impacted and the quantity of communications resources required for updating an inference model may be reduced when compared to transferring unlabeled data for inference model update purposes.

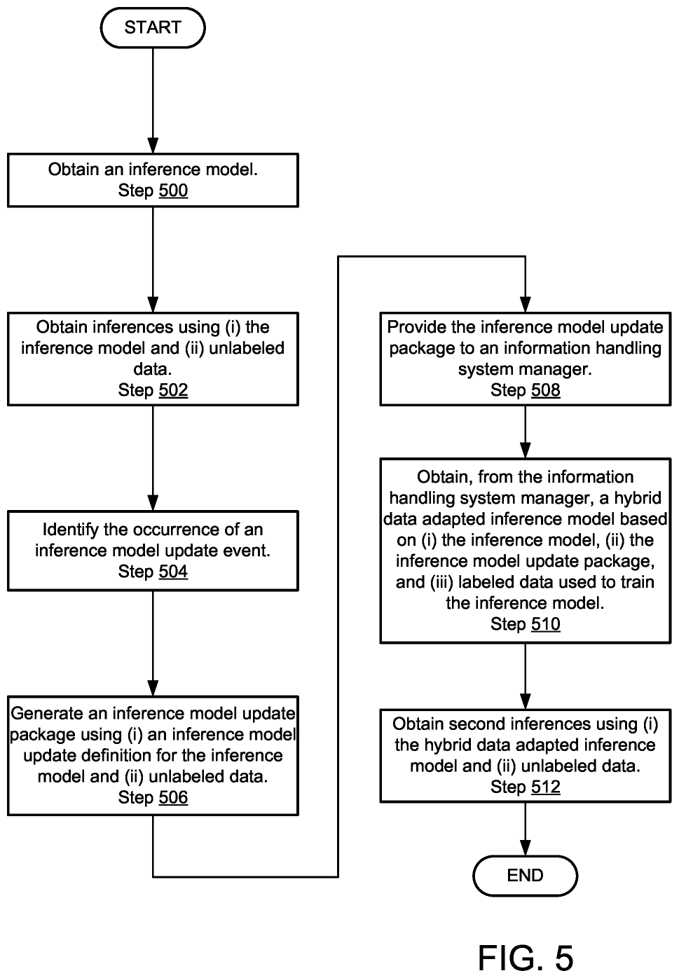

Turning to FIG. 5, FIG. 5 shows a flowchart of a method in accordance with one or more embodiments of the invention. The method depicted in FIG. 5 may be performed to identify features in unlabeled data in accordance with one or more embodiments of the invention. The method shown in FIG. 5 may be performed by, for example, an information handling system (e.g., 110, FIG. 1). Other components of the system in FIG. 1 may perform all, or a portion, of the method of FIG. 5 without departing from the invention.

While FIG. 5 is illustrated as a series of steps, any of the steps may be omitted, performed in a different order, additional steps may be included, and/or any or all of the steps may be performed in a parallel and/or partially overlapping manner without departing from the invention.

In step 500, an inference model is obtained. The inference model may be obtained from an information handling system manager. An inference model update definition for the inference model may also be obtained. The inference model and inference model update definition may be obtained via message passing, publish-subscribe systems, or any other method for disseminating information without departing from the invention. The inference model may be, for example, a labeled data based inference model or a hybrid data adapted inference model.

In step 502, inferences using (i) the inference model and (ii) unlabeled data are obtained. The inferences may be obtained by using the unlabeled data as input to the inference model. The inferences may specify features included in the unlabeled data.

In step 504, the occurrence of an inference model update event is identified. The occurrence may be identified by performing one or more calculations specified by the inference model update definition. For example, the inference model update definition may specify a series of actions that when performed identify whether the inference model is accurately identifying features in the unlabeled data. The inference model update event may be when it is identified the inference model is not accurately identifying the features in the unlabeled data.

In step 506, an inference model update package is generated using (i) the inference model update definition and (ii) unlabeled data. The inference model update package may be obtained by performing one or more actions specified by the inference model update definition. These actions may include performing one or more calculations using the unlabeled data to obtain an unlabeled data update, adding the unlabeled data update to the inference model update package, adding an identifier and/or copy of the inference model to the inference model update package, and/or adding other information to the inference model update package.

In step 508, the inference model update package is provided to an information handling system manager (e.g., that generated and/or has access to the inference model and/or labeled data upon which the inference model is based). The update package may be provided via message passing, publish-subscribe systems, or any other method for disseminating information without departing from the invention.

In step 510, a hybrid data adapted inference model based on (i) the inference model, (ii) the inference model update package, and (iii) the labeled data used to train the inference model is obtained from the information handling system manager. The hybrid data adapted inference model may be obtained by updating the inference model using the unlabeled data update from the inference model update package and a labeled data update calculated using the labeled data, as discussed with respect to FIGS. 2.1-3.2.

In step 512, second inferences are obtained using (i) the hybrid data adapted inference model and (ii) the unlabeled data. The second inferences may be obtained by using the unlabeled data as input to the hybrid data adapted inference model. The second inferences may specify features included in the unlabeled data. The features specified by the second inferences may be more accurately identified than features identified using the inference model.

The method may end following step 512. Using the method illustrated in FIG. 5, inference models may be updated to provide more accurate feature identification services while avoiding sending copies of unlabeled data to other entities. By doing so, the privacy of the unlabeled data may be maintained and the communications resources used to update the inference models may be reduced when compared to methods of updating inference models that may include moving unlabeled data between devices (e.g., because the results of calculations performed for update purposes on the unlabeled data may be much smaller in size than the unlabeled data).

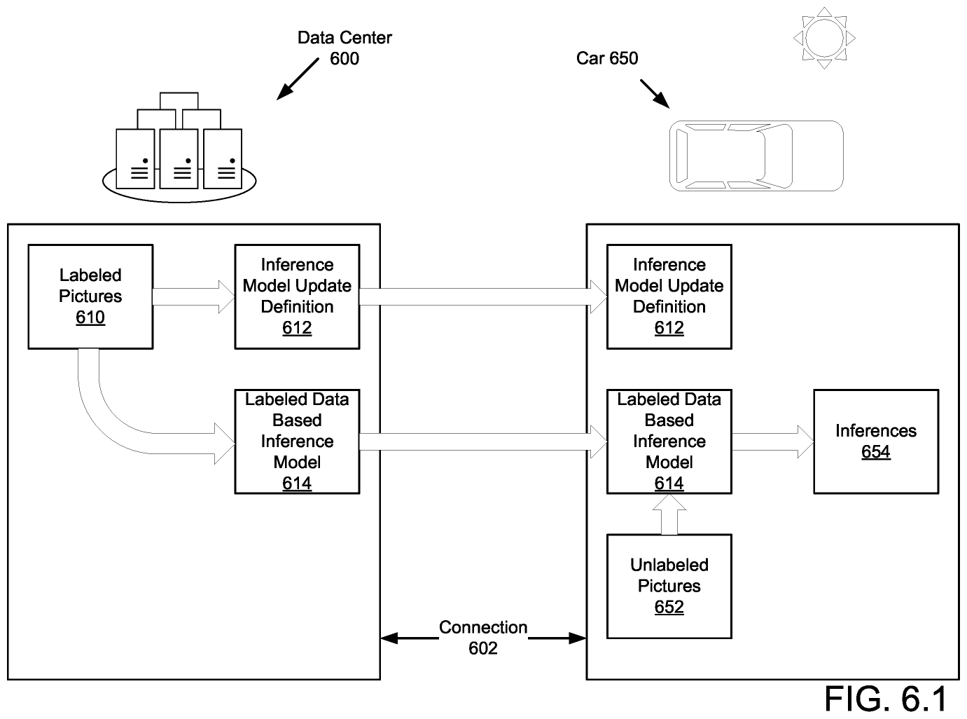

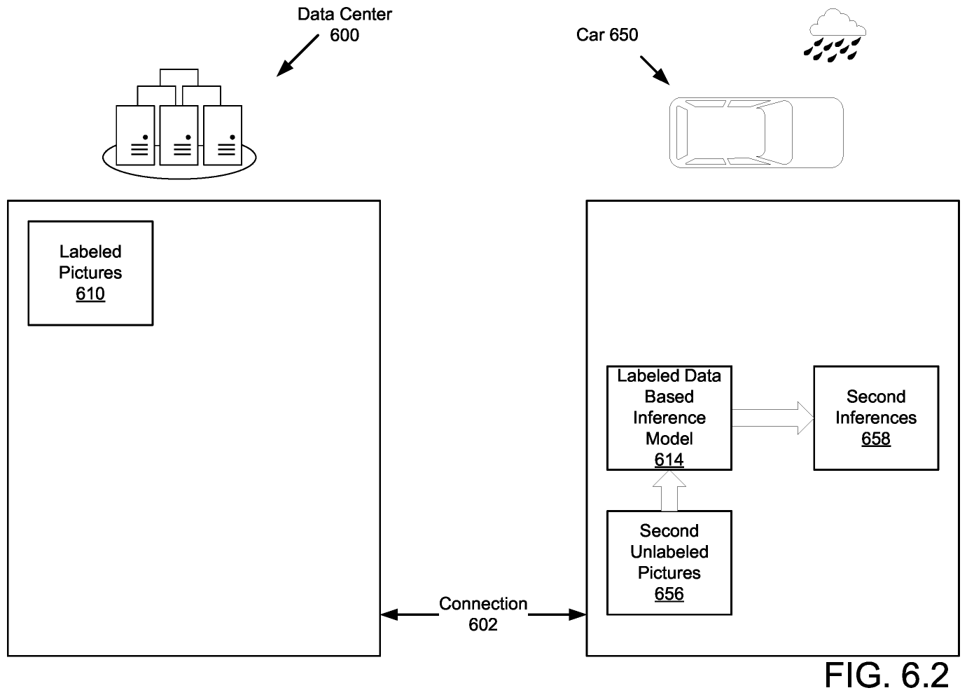

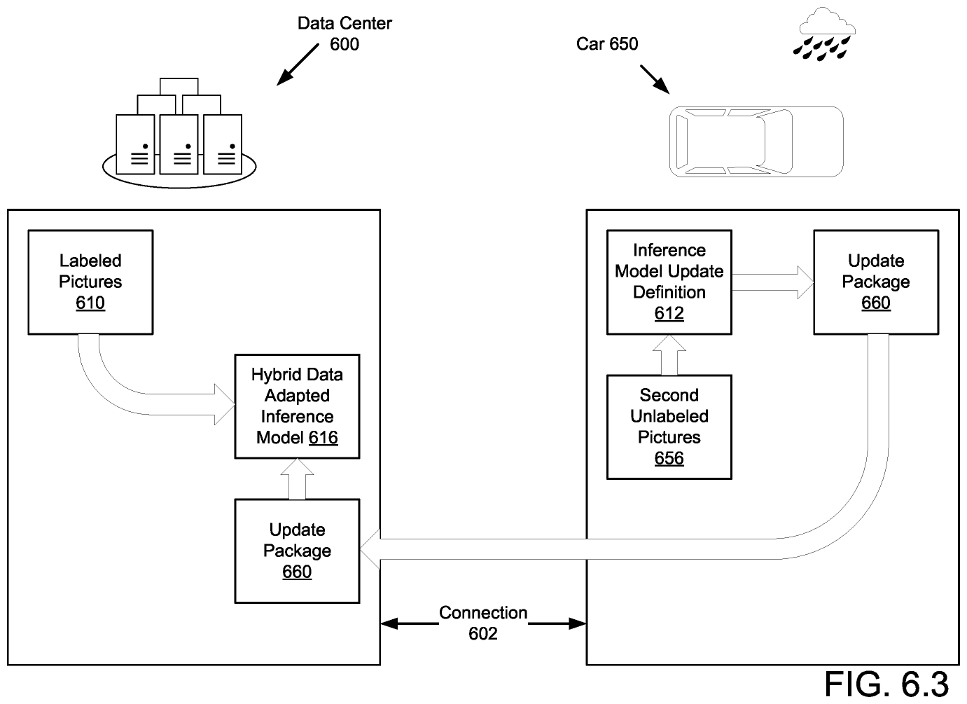

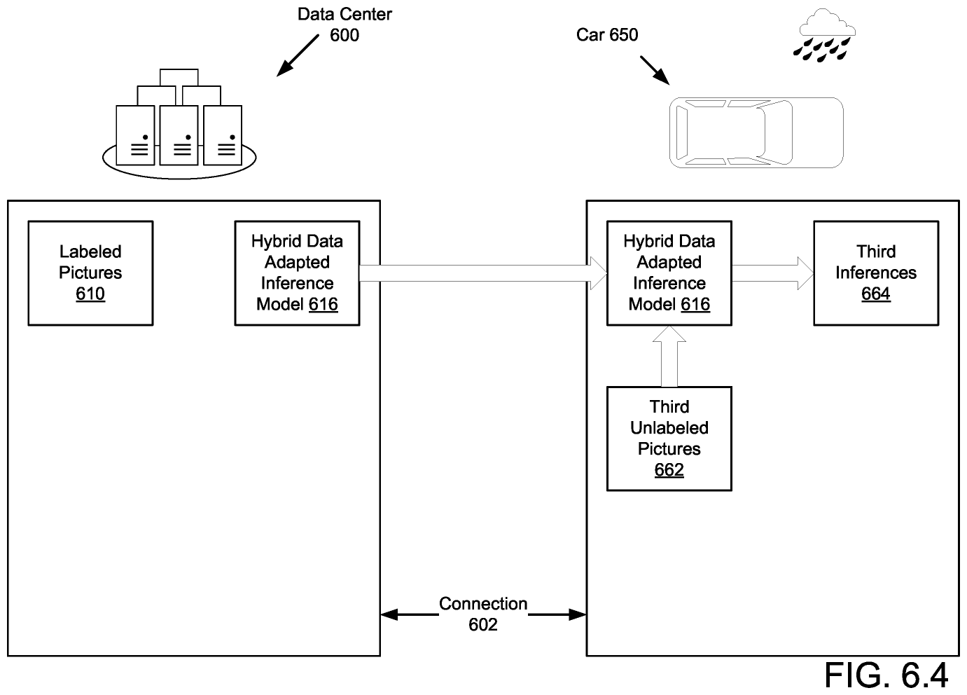

To further clarify embodiments of the invention, a non-limiting example is provided in FIGS. 6.1-6.4. These figures illustrate diagrams of the operation of a system similar to that of FIG. 1 over time.

### Example

Consider a scenario in which an information handling system is integrated into a car (650) located in sunny Texas. To provide automated navigation services, the information handling system may utilize images of the surrounding environment captured using any number of cameras as well as types of environmental information captured using other sensors. The captured images may include features relevant for determining how to provide the navigation services (e.g., provided by a navigation application hosted by the information handling system).

To enable the information handling system to identify the features in the car, a data center (600) may use labeled pictures taken by similar cars in the Texas region also exposed to generally sunny environmental conditions to generate a labeled data based inference model (614) and an inference model update definition (612) for the car (650). The resulting labeled data based inference model (614) is able to identify features in images with high accuracy so long as the images are of scenes with similar, sunny environmental conditions.

The data center (600) may transfer the model and definition to the information handling system hosted by the car (650) via a connection (602). The connection (602) may include a wireless network that provides the car (650) with limited communications capabilities. Consequently, it may not be possible to transfer significant amounts of data to and from the car (650).

After the information handling system of the car (650) obtains the labeled data based inference model (614), it begins to processes unlabeled pictures (652) to obtain inferences (654) that specify features included in the unlabeled pictures. Consequently, the navigation services provided by the information handling system (e.g., route planning, driver alerts due to road conditions, etc.) may be improved based on the accurate feature identification provided by the inference model.

After successfully providing navigation services using the identified features, the owner of the car (650) moves to the Washington state in the pacific north west. Turning to FIG. 6.2, the information handling system in the car (650) continues to use the labeled data based inference model (614) to identify features included in second unlabeled pictures (656) taken while in Washington. However, due to the rainy conditions in Washington, the second unlabeled pictures (656) are substantially different from the labeled pictures (610). Consequently, the second inferences (658) made for the second unlabeled pictures (656) inaccurately identify features included in the second unlabeled pictures (656). Accordingly, the provided navigation services are of poorer quality (e.g., less accurate).

Turning to FIG. 6.3, based on the poorer quality of inferences, the information handling system initiates a retraining the inference model. To do so, it generates an update package (660) by performing predetermined processing of the second unlabeled pictures (656) based on actions specified by the inference model update definition (612). The update package (660) is then provided to the data center which it uses, along with the labeled pictures (610) to generate a hybrid data adapted inference model (616). By virtue of being based in part on the update package, the hybrid data adapted inference model (616) is better able to identify features in images having (e.g., rainy environmental conditions) a character similar to that of the second unlabeled pictures (656).

Turning to FIG. 6.4, the data center (600) provides the information handling system with the hybrid data adapted inference model (616) via the connection (602). Once obtained, the information handling system processes third unlabeled pictures (662) to obtain third inferences (664). Because the third unlabeled pictures (662) are similar in character to the second unlabeled pictures, the third inferences (664) accurately specify the features included in the third unlabeled pictures (662).

Accordingly, the navigation services provided by the information handling system are returned to a desired level of quality by virtue of having access to the accurately identified features.

### End of Example

Thus, as illustrated in FIGS. 6.1-6.4, embodiments of the invention may provide a method for accurately identifying features in unlabeled data even as the character of the unlabeled data deviates from that of the data on which the inference model used to identify the features is based. Further, as seen in FIGS. 6.2-6.4, the processes of maintaining the accuracy of identifying features in the unlabeled data does not require sending of any of the unlabeled data to other devices. Consequently, the privacy of the unlabeled data may be maintained while also conserving the limited communications resources of the connection between the information handling system and other devices.

As discussed above, embodiments of the invention may be implemented using computing devices. FIG. 7 shows a diagram of a computing device in accordance with one or more embodiments of the invention. The computing device (700) may include one or more computer processors (702), non-persistent storage (704) (e.g., volatile memory, such as random access memory (RAM), cache memory), persistent storage (706) (e.g., a hard disk, an optical drive such as a compact disk (CD) drive or digital versatile disk (DVD) drive, a flash memory, etc.), a communication interface (712) (e.g., Bluetooth interface, infrared interface, network interface, optical interface, etc.), input devices (710), output devices (708), and numerous other elements (not shown) and functionalities. Each of these components is described below.

In one embodiment of the invention, the computer processor(s) (702) may be an integrated circuit for processing instructions. For example, the computer processor(s) may be one or more cores or micro-cores of a processor. The computing device (700) may also include one or more input devices (710), such as a touchscreen, keyboard, mouse, microphone, touchpad, electronic pen, or any other type of input device. Further, the communication interface (712) may include an integrated circuit for connecting the computing device (700) to a network (not shown) (e.g., a local area network (LAN), a wide area network (WAN) such as the Internet, mobile network, or any other type of network) and/or to another device, such as another computing device.

In one embodiment of the invention, the computing device (700) may include one or more output devices (708), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (702), non-persistent storage (704), and persistent storage (706). Many different types of computing devices exist, and the aforementioned input and output device(s) may take other forms.

Embodiments of the invention may provide a system and method for identifying features in unlabeled data. Specifically, embodiments of the invention may provide for system for maintaining the accuracy of feature identification even as the character of the unlabeled data deviates from the data upon which an inference model used to identify the features is based. To do so, a system in accordance with embodiments of the invention may retrain inference models as the data for which features are to be identified changes over time. The process of retraining the inference models may note require sending of any unlabeled data to other devices. Consequently, the privacy of the unlabeled data may be maintained while also conserving limited communications resources.

Thus, embodiments of the invention may address the problem of feature identification in unlabeled data which may need to remain private.

The problems discussed above should be understood as being examples of problems solved by embodiments of the invention and the invention should not be limited to solving the same/similar problems. The disclosed invention is broadly applicable to address a range of problems beyond those discussed herein.

One or more embodiments of the invention may be implemented using instructions executed by one or more processors of a computing device. Further, such instructions may correspond to computer readable instructions that are stored on one or more non-transitory computer readable mediums.

While the invention has been described above with respect to a limited number of embodiments, those skilled in the art, having the benefit of this disclosure, will appreciate that other embodiments can be devised which do not depart from the scope of the invention. Accordingly, the scope of the invention should be limited only by the attached claims.

What is claimed is:

1. An information handling system, comprising:
storage for storing:
collected data, and
inference models;
a processor programmed to:
identify an occurrence of an inference model update event for an inference model of the inference models;
in response to the inference model update event:
generate an inference model update package for the inference model, the inference model update package comprising a result of a calculation performed on a portion of the collected data usable to partially adapt the inference model to detect a feature in the portion of the collected data;
provide the inference model update package to an entity that generated the inference model;
obtain, from the entity, a hybrid data adapted inference model that is based on:
the inference model,
the inference model update package, and
labeled data used to train the inference mode and stored in the entity; and
obtain an inference, using the hybrid data adapted inference model and a second portion of the collected data, that indicates a second feature is present in the second portion of the collected data.

2. The information handling system of claim 1, wherein the processor is further programmed to:
prior to identifying the occurrence of the inference model update event:
obtain a second inference, using a labeled data adapted inference model of the inference models and the second portion of the collected data, that indicates that the second feature is not present in the second portion of the collected data.

3. The information handling system of claim 2, wherein the labeled data adapted inference model is not based on unlabeled data.

4. The information handling system of claim 3, wherein the unlabeled data comprises features, for which the inference models are adapted to identify, which are not identified in the unlabeled data

5. The information handling system of claim 4, wherein the labeled data comprises features, for which the inference models are adapted to identify, which are identified in the labeled data.

6. The information handling system of claim 3, wherein the portion of the collected data consists of unlabeled data.

7. The information handling system of claim 1, wherein the result comprises a gradient and a target loss for a neural network.

8. The information handling system of claim 1, wherein the hybrid data adapted inference model is obtained prior to the portion of the collected data being provided to the entity.

9. The information handling system of claim 1, wherein the inference model update package further comprises the inference model.

10. The information handling system of claim 1, wherein the inference model update event is a change in a natural environment in which the information handling system is disposed.

11. A method for detecting features in collected data hosted by an information handling system using inference models, comprising:
identifying an occurrence of an inference model update event for an inference model of the inference models;
in response to the inference model update event:
generating, by the information handling system, an inference model update package for the inference model, the inference model update package comprising a result of a calculation performed on a portion of the collected data usable to partially adapt the inference model to detect a feature of the features in the portion of the collected data;
providing the inference model update package to an entity that is operably connected to the information handling system by a network and that generated the inference model;
obtaining, by the information handling system and from the entity, a hybrid data adapted inference model that is based on:
the inference model,
the inference model update package, and
labeled data used to train the inference mode and stored in the entity; and
obtaining, by the information handling system, an inference, using the hybrid data adapted inference model and a second portion of the collected data, that indicates a second feature of the features is present in the second portion of the collected data.

12. The method of claim 11, further comprising:
prior to identifying the occurrence of the inference model update event:
obtaining, by the information handling system, a second inference, using a labeled data adapted inference model and the second portion of the collected data, that indicates that the second feature is not present in the second portion of the collected data.

13. The method of claim 12, wherein the labeled data adapted inference model is not based on unlabeled data.

14. The method of claim 13, wherein the unlabeled data comprises features, for which the inference models are adapted to identify, which are not identified in the unlabeled data

15. The method of claim 14, wherein the labeled data comprises features, for which the inference models are adapted to identify, which are identified in the labeled data.

16. A non-transitory computer readable medium comprising computer readable program code, which when executed by a computer processor enables the computer processor to perform a method for detecting features in collected data hosted by an information handling system using inference models, the method comprising:
identifying an occurrence of an inference model update event for an inference model hosted of the inference models;
in response to the inference model update event:
generating, by the information handling system, an inference model update package for the inference model, the inference model update package comprising a result of a calculation performed on a portion of the collected data usable to partially adapt the inference model to detect a feature in the portion of the collected data;
providing the inference model update package to an entity that is operably connected to the information handling system by a network and that generated the inference model;
obtaining, by the information handling system and from the entity, a hybrid data adapted inference model that is based on:
the inference model,
the inference model update package, and
labeled data used to train the inference mode and stored in the entity; and
obtaining, by the information handling system, an inference, using the hybrid data adapted inference model and a second portion of the collected data, that indicates a second feature is present in the second portion of the collected data.

17. The non-transitory computer readable medium of claim 16, wherein the method further comprises:
prior to identifying the occurrence of the inference model update event:
obtaining, by the information handling system, a second inference, using a labeled data adapted inference model and the second portion of the collected data, that indicates that the second feature is not present in the second portion of the collected data.

18. The non-transitory computer readable medium of claim 17, wherein the labeled data adapted inference model is not based on unlabeled data.

19. The non-transitory computer readable medium of claim 18, wherein the unlabeled data comprises features, for which the inference models are adapted to identify, which are not identified in the unlabeled data

20. The non-transitory computer readable medium of claim 19, wherein the labeled data comprises features, for which the inference models are adapted to identify, which are identified in the labeled data.
